(19) United States
(12) Patent Application Publication
(10) Pub. No.: US 2026/0342703 A1
(43) Pub. Date: Oct. 29, 2026

(54) COMMUNICATION DEVICE, COMMUNICATION SYSTEM, AND FAILURE SIGN DIAGNOSIS METHOD

(71) Applicant: Hitachi Astemo, Ltd., Hitachinaka-shi, Ibaraki (JP)

(72) Inventor: Masato KITA, Hitachinaka-shi, Ibaraki (JP)

(73) Assignee: Hitachi Astemo, Ltd., Hitachinaka-shi, Ibaraki (JP)

(21) Appl. No.: 19/110,992

(22) PCT Filed: Nov. 7, 2022
(86) PCT No.: PCT/JP2022/041318

§ 371 Date: Mar. 12, 2025

(51) Int. Cl. H04L 43/0823

(52) U.S. Cl. CPC H04L 43/0823

(57) ABSTRACT

A communication device transmits a data signal and includes a setpoint data variation diagnosis unit that, using first setpoint data for adjusting a transmission waveform when the data signal is transmitted and received to and from an external device via a transmission line, and second setpoint data for adjusting a transmission waveform when the data signal is looped back between a transmission circuit and a reception circuit in a transmission device, determines, based on a prescribed determination condition, each of a variation in the first setpoint data when the data signal is transmitted and received to and from the external device via the transmission line and a variation in the second setpoint data when the data signal is looped back between the transmission circuit and the reception circuit, and diagnoses, based on determination results, failure signs of the communication device and the transmission line.

### TECHNICAL FIELD

The present invention relates, for example, to a communication device having a function for performing failure sign diagnosis in data communication via an in-vehicle network, and to a communication system and a failure sign diagnosis method.

### BACKGROUND ART

In recent years, data communication has become indispensable in industrial and life infrastructures, and it is desirable that a failure sign can be ascertained before a communication device fails. For example, for semiconductor components installed in an automobile, securing long-term reliability becomes difficult when the rate of operation of the automobile increases significantly due to the spread of self-driving and car-sharing services. For this reason, in the future, it is considered that the function of a semiconductor component is mainly maintained through component replacement. Semiconductors used in communication devices that perform data communication with in-vehicle sensors or a camera are deeply involved in safety control, and hence it is necessary to establish a diagnosis method that focuses on failure sign diagnosis.

PTL 1 discloses a method for diagnosing a failure sign by comparing setpoint data for adjusting a transmission waveform during communication with diagnosis reference information.

### CITATION LIST

### Patent Literature

PTL 1: JP 2017-129969 A

### SUMMARY OF INVENTION

### Technical Problem

For example, in a case where a failure sign is detected on a communication path in which a first communication device and a second communication device are connected via a transmission line by using the features of Patent Literature 1, it is possible to ascertain that the diagnosed communication path is in a failure sign state. However, it is not possible to specify whether the location of a failure sign is the first communication device, the second communication device, or the transmission line. For this reason, a number of maintenance steps for specifying the actual failure sign location are required, and in a case where the failure sign location cannot be specified, more components or communication devices than necessary are replaced as a precaution for a suspicious component or communication device, resulting in an increase in cost.

In view of the above circumstances, there has been a demand for a method that makes it possible to at least ascertain whether or not a communication device to be diagnosed is in a failure sign state.

### Solution to Problem

In order to solve the above problem, a communication device according to an aspect of the present invention is a communication device that transmits a data signal, the communication device including: a transmission circuit that transmits a data signal; a reception circuit that receives the data signal; and a setpoint data variation diagnosis unit that,
using first setpoint data for adjusting a transmission waveform when a data signal is transmitted and received to and from an external device via a transmission line, and second setpoint data for adjusting a transmission waveform when a data signal is looped back between the transmission circuit and the reception circuit, determines, based on a prescribed determination condition, each of a variation in the first setpoint data when the data signal is transmitted and received to and from the external device via the transmission line and a variation in the second setpoint data when the data signal is looped back between the transmission circuit and the reception circuit, and diagnoses, based on determination results, failure signs of the communication device and the transmission line.

### Advantageous Effects of Invention

According to at least one aspect of the present invention, by adding a failure sign diagnosis at the time of loopback to a diagnosis at the time of transmission/reception to/from an external device via a transmission line, self-diagnosis by the communication device itself becomes possible, and it is possible to ascertain whether or not the communication device to be diagnosed is in the failure sign state.

Problems, configurations, and effects other than those described above will be clarified by the description of the embodiments hereinbelow.

### BRIEF DESCRIPTION OF DRAWINGS

FIG. 1 is a block diagram illustrating an internal configuration example of a communication device constituting a communication system according to a first embodiment of the present invention.

FIG. 2 is a diagram illustrating an example of temporal variation of setpoint data for transmission waveform adjustment according to the first embodiment of the present invention.

FIG. 3 is a diagram illustrating a table in which failure sign diagnosis results of the t communication devices alone according to the first embodiment of the present invention are grouped.

FIG. 4 is a diagram illustrating a table in which failure sign diagnosis results of two communication devices according to the first embodiment of the present invention are grouped.

FIG. 5 is a block diagram illustrating an internal configuration example in a case where a temperature detector is provided in the communication device according to the first embodiment of the present invention.

FIG. 6 is a block diagram illustrating an internal configuration example in a case where a power supply voltage detector is provided in the communication device according to the first embodiment of the present invention.

FIG. 7 is a diagram illustrating an example of a configuration, in a communication system according to the first embodiment of the present invention, in which information on a failure sign diagnosis result is aggregated in a host device and a failure sign location is specified by the host device.

FIG. 8 is a diagram illustrating an example of a configuration, in a communication system according to a second embodiment of the present invention, in which a failure sign location is specified by a communication device without using a host device.

FIG. 9 is a diagram illustrating an example of a configuration, in a communication system according to a third embodiment of the present invention, in which determination threshold values used in failure sign diagnosis of a communication device are changed according to an instruction from an external device.

FIG. 10 is a diagram illustrating an example of a configuration, in a communication system according to a third embodiment of the present invention, in which an instruction from an external device is transmitted and received between two communication devices by means of radio communication.

FIG. 11 is a block diagram illustrating a hardware configuration example of a computer included in a communication device, a microcomputer, and a server according to the first embodiment of the present invention.

### DESCRIPTION OF EMBODIMENTS

Hereinbelow, examples of modes for carrying out the present invention (referred to hereinafter as “embodiments”) will be described with reference to the accompanying drawings. In the present specification and the attached drawings, the same components or components having substantially the same functions are denoted by the same reference signs, and thus redundant descriptions thereof are omitted. In addition, in cases where there is a plurality of components having the same or similar functions, descriptions are sometimes provided by adding different subscripts to the same reference signs. Furthermore, in cases where it is not necessary to distinguish the plurality of components, descriptions may be provided with subscripts omitted.

### First Embodiment

First, a communication device according to a first embodiment of the present invention and a communication system using the communication device will be described.

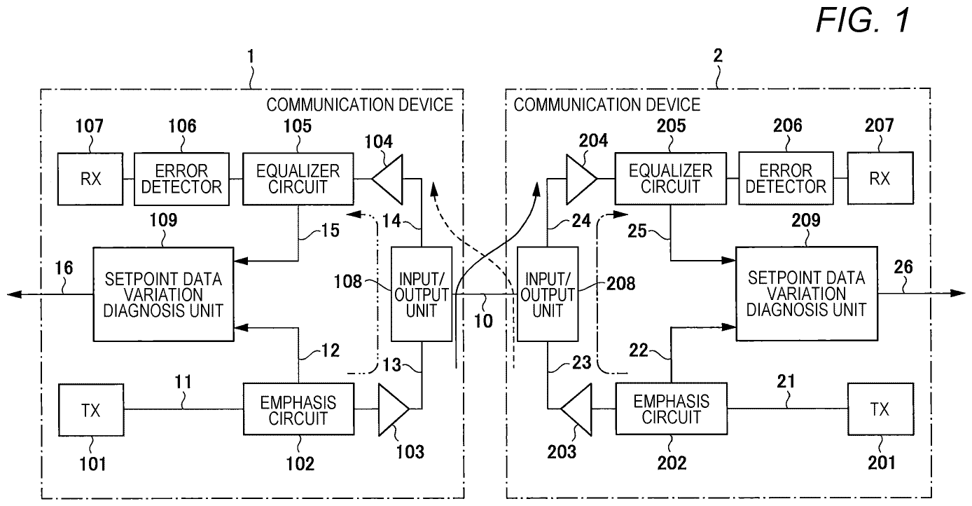

FIG. 1 is a block diagram illustrating an internal configuration example of a communication device constituting a communication system according to the first embodiment. In the example illustrated in FIG. 1, the communication device 1 and the communication device 2 are connected by one transmission line 10. In the case of in-vehicle Ethernet (registered trademark), the transmission line 10 is a set of twisted pair cables (differential transmission lines). Full duplex communication can be performed between the communication device 1 and the communication device 2 using a twisted pair cable. For example, the communication device 1 and the communication device 2 are used as in-vehicle Ethernet switches.

### Configuration of Communication Device 1

In the communication device 1, the transmission circuit includes a transmission processing circuit 101, an emphasis circuit 102, and a transmission output circuit 103, and the reception circuit includes a reception input circuit 104, an equalizer circuit 105, an error detector 106, and a reception processing circuit 107. In addition, the communication device 1 includes an input/output unit 108 and a setpoint data variation diagnosis unit 109 that diagnoses variations in setpoint data for transmission waveform adjustment, which will be described in detail below.

The transmission processing circuit 101 performs processing to convert data (for example, IP packets) outputted from the input/output unit 108 into a signal (referred to as a “data signal”) suitable for transmission, and outputs the data signal to the emphasis circuit 102 via a signal line 11. In the drawings, the transmission processing circuit 101 appears as “TX”.

The emphasis circuit 102 amplifies the radio frequency band of the data signal inputted from the transmission processing circuit 101 according to the attenuation characteristic at a high frequency which is unique to the transmission line, and outputs the data signal to the transmission output circuit 103. As a result, the frequency characteristic of the data signal received by the communication device 2 on the reception side is improved. In addition, the emphasis circuit 102 outputs setpoint data 1 for transmission waveform adjustment (obtained by indexing values of tap coefficients for adjusting a transmission waveform) to be described below to the setpoint data variation diagnosis unit 109 via a signal line 12. Generally, the emphasis circuit 102 is implemented by a compensation circuit that uses a frequency filter or the like for performing adjustment so as to optimize the frequency characteristic of the data signal.

The transmission output circuit 103 amplifies, using a preset gain, the data signal inputted from the emphasis circuit 102, and outputs the data signal to the input/output unit 108 via the signal line 13.

The input/output unit 108 performs processing (solid line) to output the data signal inputted from the transmission output circuit 103 to the transmission line 10. In addition, a data signal is inputted from the communication device 2 to the input/output unit 108 via the transmission line 10 (the broken line). Furthermore, the input/output unit 108 outputs the data signal inputted from the transmission output circuit 103 at the time of loopback to the reception input circuit 104 via the signal line 14 (the two-dot chain line). Similarly in the communication device 2, the input/output unit 208 outputs the data signal inputted from the transmission output circuit 203 at the time of loopback to the reception input circuit 204 via the signal line 24 (the one-dot chain line).

The reception input circuit 104 amplifies, using a preset gain, the data signal inputted from the input/output unit 108, and outputs the data signal to the equalizer circuit 105.

After receiving the data signal from the reception input circuit 104, the equalizer circuit 105 adjusts the frequency characteristic of the data signal and outputs the data signal to the error detector 106 for the purpose of restoring the signal waveform changed by the characteristics of the transmission line and minimizing the change. In addition, the equalizer circuit 105 outputs setpoint data 2 of transmission waveform adjustment (obtained by indexing values of tap coefficients for adjusting a transmission waveform) to be described below to the setpoint data variation diagnosis unit 109 via a signal line 15. The equalizer circuit 105 is implemented by a compensation circuit that uses a frequency filter or the like for performing adjustment so as to optimize the frequency characteristic of the data signal. In many cases, amplification of a high frequency band is performed on a signal transmitted from a transmission line for the purpose of reinforcing a lost radio frequency component.

The error detector 106 compares the data signal inputted from the equalizer circuit 105 with a prescribed data signal to detect an error, and outputs an error detection result to the reception processing circuit 107 together with the data signal.

The reception processing circuit 107 receives a data signal and an error detection result, and performs processing to convert the data signal into data which is suitable for use in a processing block or a device in a subsequent stage (not illustrated). In the drawings, the reception processing circuit 107 appears as “RX”.

The setpoint data variation diagnosis unit 109 monitors variations in each of the setpoint data 1 of the transmission waveform adjustment acquired from the emphasis circuit 102 and the setpoint data 2 of the transmission waveform adjustment acquired from the equalizer circuit 105, and diagnoses failure signs of the communication device and the transmission line. The setpoint data variation diagnosis unit 109 outputs a failure sign diagnosis result to a device outside the communication device 1 via a signal line 16.

### Configuration of Communication Device 2

In the communication device 2, the transmission circuit includes a transmission processing circuit 201, an emphasis circuit 202, and a transmission output circuit 203, and the reception circuit includes a reception input circuit 204, an equalizer circuit 205, an error detector 206, and a reception processing circuit 207. In addition, the communication device 2 includes an input/output unit 208 and a setpoint data variation diagnosis unit 209, which will be described in detail below.

The transmission processing circuit 201, the emphasis circuit 202, and the transmission output circuit 203 constituting the transmission circuit have configurations similar to those of the transmission processing circuit 101, the emphasis circuit 102, and the transmission output circuit 103 of the communication device 1. Furthermore, the reception input circuit 204, the equalizer circuit 205, the error detector 206, and the reception processing circuit 207 constituting the reception circuit have the same configurations as the reception input circuit 104, the equalizer circuit 105, the error detector 106, and the reception processing circuit 107 of the communication device 1. The input/output unit 208 and the setpoint data variation diagnosis unit 209 have the same configurations as the input/output unit 108 and the setpoint data variation diagnosis unit 109 of the communication device 1. Descriptions of these processing blocks of the communication device 2 will be omitted. The signal lines 21 to 26 correspond to the signal lines 11 to 16 of the communication device 1.

Because the communication device 1 and the communication device 2 are affected by the frequency characteristic of the transmission line 10 when transmitting and receiving data signals, the communication device 1 and the communication device 2 adjust transmission waveforms. The circuits responsible for this adjustment function are the emphasis circuits 102 and 202 on the transmission side and the equalizer circuits 105 and 205 on the reception side.

The emphasis circuits 102 and 202 are, for example, finite impulse response (FIR)-type digital filters (frequency filters). In a FIR type digital filter (hereinafter, “FIR filter”), for example, in a case where the number of taps of a transfer function is three, the transmission waveform can be adjusted by means of three tap coefficients. Hereinafter, the tap coefficients are also simply referred to as “coefficients”.

The equalizer circuits 105 and 205 are, for example, decision feedback equalizers (DFEs) for which digital filters (frequency filters) are used. In a DFE, for example, in a case where the number of taps of the transfer function is three, the transmission waveform can be adjusted by means of three tap coefficients.

In the emphasis circuits 102 and 202 and the equalizer circuits 105 and 205, values obtained by indexing the values of the tap coefficients for adjusting the transmission waveform are referred to as “setpoint data for transmission waveform adjustment”. However, “setpoint data for transmission waveform adjustment” may be abbreviated to “setpoint data”. In the present embodiment, at least a change in either the setpoint data of the emphasis circuit or the setpoint data of the equalizer circuit is monitored to capture a failure sign.

Because the FIR filter and the DFE are similar in that both are digital filters, an example of a case where a FIR filter is used will be described here. The formula for a FIR filter transfer function is expressed by H(z)=a0+(a1×Z−1)+(a2×Z−2), and three coefficients in the formula are a0, a1, and a2. For example, the rates of change from the initial state values are calculated for each of the three coefficients a0, a1, and a2, and values resulting from indexing using the maximum value among these rates of change are set as setpoint data for transmission waveform adjustment.

As an example, the initial state values are “a0 =−0.20, a1=+0.70, a2=−0.10”, and the subsequent state is “a0 =−0.30, a1=+0.90, a2=−0.10”. In this case, the rates of change from initial state values are a0=−50.0[%], a1=+28.6[%], and a2=0.0[%].

The absolute values of the rates of change from the initial state values are maximized at −50.0[%] of the coefficient a0, and the maximum value is 50[%]. In this case, the indexed value is −50. Here, by way of example, the percentage values are normalized as values from 0 to 100. The setpoint data for transmission waveform adjustment (values obtained by indexing the values of the tap coefficients for adjusting the transmission waveform) tends to change at a larger rate from the initial state values as the deterioration of the communication devices 1 and 2 and the transmission line 10 progresses. Therefore, the setpoint data variation diagnosis unit 109 is capable of diagnosing failure signs by monitoring variations in the setpoint data for the transmission waveform adjustment.

In the above example, emphasis is placed on the maximum values of the rates of change of the three coefficients, but failure sign diagnosis may be individually performed by indexing each of the three coefficients.

In addition, an allowable range for the three coefficients may be determined, and the margin up to the allowable range may be a value obtained by indexing the minimum values of the three coefficients or a value obtained by individually indexing the three coefficients.

Furthermore, among the three coefficients, a0 and a2generate an undershoot waveform and play an important role in the adjustment of the transmission waveform, and thus may be indexed by weighting the coefficients. For example, in the above example, in the case of “a0=−0.2”→“a0=−0.3”,when the weight of the coefficient is multiplied by 1.2, the rate of change is −50[%]→−60[%]. Meanwhile, in a case where the margin is indexed by setting the allowable range, reducing the margin by a 0.8 multiple is also conceivable. As described in Patent Literature 1, focusing only on the changes in the coefficients a0 and a2 may also be considered.

Note that the FIR filter and the DFE described above are examples of an emphasis circuit and an equalizer circuit used in the transmission waveform adjustment, and are not limited to this circuit system, and include an analog signal processing circuit and the like. In addition, the number of taps is not limited to three, and in a case where the number of taps is N, the transmission waveform can be adjusted by means of N coefficients.

Usually, the setpoint data for transmission waveform adjustment is determined before the transmission and reception of a data signal is performed. For example, the transmission and reception between the communication device 1 and the communication device 2 are repeated using a prescribed signal pattern, and the setpoint data for the transmission waveform adjustment is determined so as to obtain an optimum condition in which the error in the error detectors 106 and 206 becomes 0. A technique for performing failure sign diagnosis of a communication path by using the setpoint data for the transmission waveform adjustment at the time of normal transmission and reception is known in Patent Literature 1.

In the present invention, the failure sign diagnosis is performed using setpoint data 1 (referred to as “setpoint data 1” for the sake of distinction) for the transmission waveform adjustment at the time of normal transmission/reception and setpoint data 2 (referred to as “setpoint data 2” to distinguish same from setpoint data 1) for the transmission waveform adjustment at the time of loopback from the transmission circuit to the reception circuit in the same communication device. In the present invention, in addition to self-diagnosis of the normality or abnormality of the communication device itself, it is possible to specify a failure sign location (the communication device 1, the communication device 2, or the transmission line 10) by using a diagnosis result of transmission and reception between the communication device 1 and the communication device 2.

For example, in the failure sign diagnosis during normal transmission and reception, in a case where it is determined that there is a failure sign in the course of “transmission by the communication device 2”→“transmission line 10”→“reception by the communication device 1”, it is possible to ascertain that there is an abnormality in the communication path, but it is not possible to specify the failure sign location. Therefore, in the present invention, by adding the failure sign diagnosis at the time of loopback, information on the self-diagnosis result can be obtained for each of the communication device 1 and the communication device 2, and hence it is possible to specify the failure sign location. When there is a response regarding normal reception from a communication device (for example, the communication device 1) serving as the transmission destination, it is possible to confirm that communication is normal. The presence or absence of a response from the communication partner is checked by the communication device which has transmitted the data signal or by a host device to be described below.

The signal path at the time loopback within the same communication device, for example the communication device 1, is “transmission processing circuit 101”→“emphasis circuit 102”→“transmission output circuit 103”→“signal line 13”→“input/output unit 108”→“signal line 14”→“reception input circuit 104”→“equalizer circuit 105”→“error detector 106”.

Similarly to normal transmission and reception, the setpoint data 2 for transmission waveform adjustment is determined so as to yield the optimum condition that the error in the error detector 106 of the communication device 1 becomes 0. The same applies to the communication device 2, and thus a description thereof will be omitted.

At the time of loopback, because the transmission line 10 is not included in the communication path, the distortion of the transmission waveform is small. Therefore, it is more effective to adjust the transmission waveform in the emphasis circuit 102 and the equalizer circuit 105 under a setting condition different from that at the time of normal transmission/reception. For example, in the setting of the tap coefficients of the transfer function in the emphasis circuit 102, the signal amplitude is set to be small. Alternatively, the gain for the entire signal in the transmission output circuit 103 or the gain for the entire signal in the reception input circuit 104 is adjusted to set a lower signal amplitude.

In addition, regarding the signal pattern at the time an optimum condition is examined, a diagnosis pattern that is likely to cause an error, such as a case where a Hi level during continuation of a Lo level occurs only once, or conversely, a case where the Lo level during continuation of the Hi level occurs only once, is, in failure sign diagnosis, is considered to be more suitable for capturing a change. In a diagnosis pattern that is likely to cause an error, an error is likely to be detected by the error detector 106. Furthermore, as a diagnosis pattern that is likely to cause an error, a diagnosis pattern obtained by raising the signal frequency and narrowing the interval of the time axis is also conceivable.

Although not illustrated in the present embodiment, in the case of a configuration in which full-duplex communication is performed via one transmission line (for example, using different bands), an echo canceller circuit (not illustrated) for removing a transmission signal included in a reception signal is installed. In a case where the echo canceller function works at the time of loopback and the looped back signal is removed, it is necessary to take measures such as disabling the echo cancellation function. For example, a circuit that disables the echo cancellation function is provided at least at a preceding stage of the equalizer circuit 105, such as between the input/output unit 108 and the reception input circuit 104.

Furthermore, at the time of loopback in the communication device 1, on occasion there is an impact such as an electric signal being reflected by the connected transmission line 10, or an impact from a data signal received from the communication device 2. In such a case, for example, a method may be considered in which the input/output unit 108 is provided with a function for blocking the transmission line 10 by means of a switch circuit or the like, and failure sign diagnosis is performed at the time of loopback in a state where the transmission line 10 is blocked.

Note that the failure sign diagnosis needs to be performed using timing that does not interfere with normal communication. For example, the timing at which the setpoint data variation diagnosis unit 109 performs the failure sign diagnosis is desirably at the time of activation of the communication device (at the time of communication training) or at the time of termination thereof.

The setpoint data variation diagnosis unit 109 for transmission waveform adjustment diagnoses a failure sign by using the setpoint data 1 and the setpoint data 2 for transmission waveform adjustment which are obtained by indexing the tap coefficients of the transfer functions of the emphasis circuit 102 and the equalizer circuit 105.

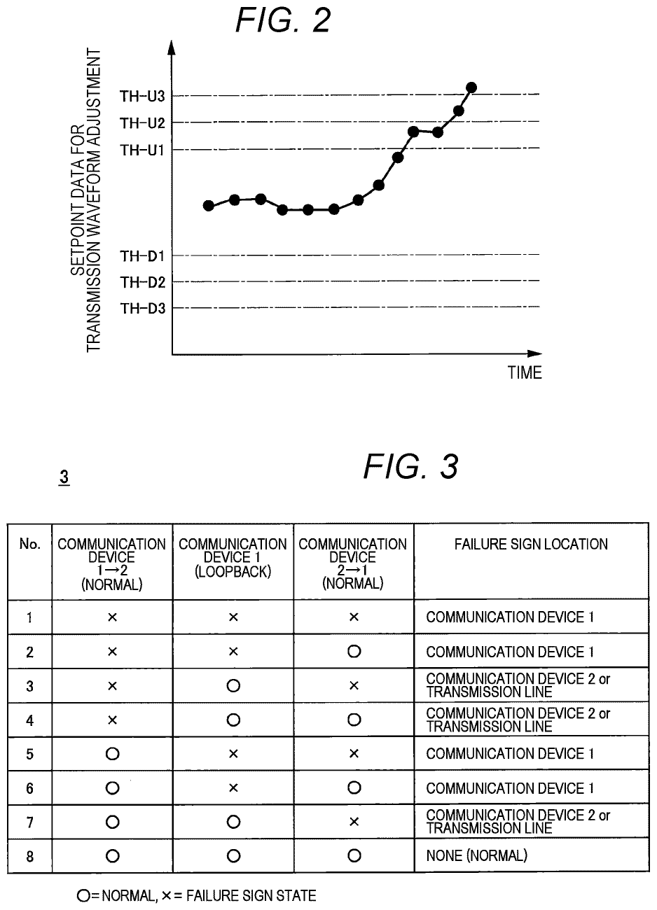

Next, temporal variation of the setpoint data for transmission waveform adjustment will be described with reference to FIG. 2.

FIG. 2 is a diagram illustrating an example of temporal variation of setpoint data for transmission waveform adjustment according to the present embodiment. FIG. 2 illustrates an example of a case where determination is made using a plurality of threshold values with the horizontal axis representing time and the vertical axis representing setpoint data for transmission waveform adjustment.

The setpoint data variation diagnosis unit 109 determines a variation (failure sign) in setpoint data based on the relationship between the Setpoint data for transmission waveform adjustment and threshold values (TH-U1, TH-U2, TH-U3, TH-D1, TH-D2, TH-D3). The magnitude relationship of the upper threshold value is TH-U1<TH-U2<TH-U3,and the magnitude relationship of the lower threshold value is TH-D1>TH-D2>TH-D3.

In this example, the value of the setpoint data for the transmission waveform adjustment varies upward as time elapses. Here, as the simplest diagnosis method, in a case where it is determined that there is a failure sign when the upper threshold value TH-U3 is exceeded, it is conceivable to determine that there is a failure sign when the value of the setpoint data for the transmission waveform adjustment simply exceeds the threshold value TH-U3. A case where the value of the setpoint data for transmission waveform adjustment falls below the lower threshold value TH-D3 is also determined as a failure sign.

In addition, the time until the failure sign (here, the threshold value TH-U3) is reached can be predicted on the basis of the time when the threshold value TH-U1 is exceeded or the time when the threshold value TH-U2 is exceeded. That is, the time when the setpoint data for transmission waveform adjustment reaches the threshold value TH-U3 can be known by the time elapsed from when the setpoint data exceeds the threshold value TH-U1 to when the setpoint data exceeds the threshold value TH-U2. Furthermore, it is also possible to estimate the failure sign situation (progress rate of component deterioration) based on the elapsed time from the threshold value TH-U1 to the threshold value TH-U3 or the elapsed time from the threshold value TH-U2 to the threshold value TH-U3. The elapsed time from the threshold value TH-U1 to the threshold value TH-U3 may be compared with the elapsed time from the threshold value TH-U2 to the threshold value TH-U3 to estimate the failure sign situation.

In addition, by chronologically acquiring the setpoint data for the transmission waveform adjustment without using the plurality of threshold values, it is also possible to predict the time until the failure sign is reached. In this case, it is assumed that at least one threshold value (for example, the threshold value TH-U3) is set. For example, the time at which the transmission waveform adjustment reaches the threshold value TH-U3 can be estimated from the degree of the slope or the rising curve of the data (time-series data) obtained by chronologically acquiring the setpoint data for the transmission waveform adjustment. It is thus possible to diagnose a failure sign by capturing temporal variations by means of the time-series data. Note that there is the advantageous effect that the amount of data is smaller in determination using a plurality of threshold values than in determination using time-series data.

Further, the acquired setpoint data for the transmission waveform adjustment can be used to diagnose a failure sign by using a statistical method or machine learning.

Next, the procedure for the failure sign diagnosis by the setpoint data variation diagnosis unit 109 will be described. For example, a case where the communication device 1 performs failure sign diagnosis at the time of activation will be described as an example. First, the communication device 1 performs failure sign diagnosis at the time of loopback and then checks, through self-diagnosis, whether there is a problem with the communication device 1 itself. Next, the communication device 1 performs failure sign diagnosis during normal transmission and reception. For example, in the communication device 1, the setpoint data variation diagnosis unit 109 acquires setpoint data of the following four patterns of transmission waveform adjustment.
(1) Setpoint data 2 for transmission waveform adjustment of emphasis circuit 102 at the time of loopback
(2) Setpoint data 2 for transmission waveform adjustment of equalizer circuit 105 at the time of loopback
(3) Setpoint data 1 for transmission waveform adjustment of emphasis circuit 102 at the time of normal transmission and reception
(4) Setpoint data 1 for transmission waveform adjustment of equalizer circuit 105 at the time of normal transmission and reception

The setpoint data variation diagnosis unit 109 then performs, based on a prescribed determination condition, failure sign diagnosis on the setpoint data for the transmission waveform adjustment of each of (1) to (4). In a case where it is determined that there is a failure sign, the setpoint data variation diagnosis unit 109 outputs a failure sign signal from the signal line 16 to a device external to the communication device 1.

Next, grouping of the failure sign diagnosis results of the communication devices alone according to the present embodiment will be described with reference to FIG. 3.

FIG. 3 is a diagram illustrating a table in which failure sign diagnosis results of the communication device 1 alone are grouped. Grouping table 3 illustrated in FIG. 3 includes the following items: “No.” , “communication device 1→2 (normal)”, “communication device 1 (loopback)”, “communication device 2→1 (normal)”, and “failure sign location”.

“No.” is an identifier (for example, a number) for uniquely identifying a row (record) in the table.

“Communication device 1→2 (normal)” indicates a normal communication state in which a data signal is transmitted from the communication device 1 to the communication device 2. In the drawing, “○” indicates normal, and “×” indicates a failure sign state.

“Communication device 1 (loopback)” indicates a communication state when the communication device 1 loops back.

“Communication device 2→1 (normal)” indicates a normal communication state in which a data signal is transmitted from the communication device 2 to the communication device 1. In the drawing, “○” indicates normal, and “×” indicates a failure sign state.

The “failure sign location” indicates a failure sign location specified from the communication states illustrated in “communication device 1→2 (normal)”, “communication device 1 (loopback)”, and “communication device (normal)”.

By adding a diagnosis at the time of loopback in addition to a diagnosis at the time of normal transmission and reception, it is possible to determine whether the communication device 1 itself is normal or in a failure sign state. However, because the failure sign state of the communication device 2 is unknown, sometimes the failure sign location cannot be specified (No. 3, No. 4, and No. 7 in FIG. 3).

For example, in the data of No. 3, “communication device 1→2 (normal)” is a failure sign state, “communication device 1 (loopback)” is a normal state, and “communication device 2→1 (normal)” is a failure sign state. In the data of No. 4, “communication device 1→2 (normal)” is a failure sign state, “communication device 1 (loopback)” is a normal state, and “communication device 2→1 (normal)” is a normal state. Furthermore, in the data of No. 7, “communication device 1→2 (normal)” is a normal state, “communication device 1 (loopback)” is a normal state, and “communication device 2→1 (normal)” is a failure sign state. In the case of any data of No. 3, No. 4, and No. 7, there is a possibility of “communication device 1” or “transmission line 10” as a failure sign location.

Note that, in the present embodiment, by adding the diagnosis at the time of loopback to the diagnosis at the time of normal transmission and reception, it may be possible to estimate in which of the transmission circuit and the reception circuit of the communication device 1 the failure sign was generated. For example, in the data of No. 2, “communication device 1→2 (normal)” is a failure sign state, “communication device 1 (loopback)” is a failure sign state, and “communication device 2→1 (normal)” is a normal state. In the case of this combination, because the “communication device 1 (loopback)” is a failure sign state and the “communication device 2→1 (normal)” is a normal state, it can be determined that there is a failure sign in the transmission circuit of the communication device 1.

Similarly, in the data of No. 5, “communication device 1→2 (normal)” is a normal state, “communication device 1 (loopback)” is a failure sign state, and “communication device 2→1 (normal)” is a failure sign state. In the case of this combination, because the “communication device 1 (loopback)” is a failure sign state and the “communication device 1→2 (normal)” is a normal state, it can be determined that there is a failure sign in the reception circuit of the communication device 1. In this manner, it is possible to estimate in which of the transmission circuit and the reception circuit in the communication device the failure sign was generated, which contributes to failure analysis of a circuit board mounted in the communication device or of the communication device.

Note that the diagnosis of the communication state, that is, the diagnosis of the failure sign may be performed in light of “communication device 1 (loopback)”. In a case where the “communication device 1 (loopback)” is a failure sign state, it can be determined that there is a failure sign in the communication device 1 regardless of the diagnosis results of the “communication device 1→2 (normal)” and the “communication device 2→1 (normal)” (see No. 1, No. 2, No. 5, and No. 6). In this way, diagnosis of “communication device 1→2 (normal)” and “communication device 2→1 (normal)” can be omitted.

As described above, the communication device (for example, the communication device 1) according to the present embodiment is a communication device that transmits a data signal, and includes transmission circuits for transmitting data signals (the transmission processing circuit 101 to the transmission output circuit 103), reception circuits for receiving data signals (the reception input circuit 104 to the reception processing circuit 107), and a setpoint data variation diagnosis unit (the setpoint data variation diagnosis unit 109).

The setpoint data variation diagnosis unit is configured to use first setpoint data for adjusting the transmission waveform when a data signal is transmitted and received to and from an external device (for example, the communication device 2) via a transmission line (communication device 1→2 (normal), communication device 2→1 (normal) ), and second setpoint data for adjusting the transmission waveform when a data signal is looped back between a transmission t circuit and a reception circuit (communication device 1 (loopback) ), to determine, based on a prescribed determination condition, a variation in the first setpoint data when the data signal is transmitted and received to and from an external device via the transmission line and a variation in the second setpoint data when the data signal is looped back between the transmission circuit and the reception circuit, and diagnose, based on the determination result, a failure sign between the communication device and the transmission line.

With the communication device (for example, communication device 1) according to the present embodiment described above, by adding the diagnosis at the time of loopback to the diagnosis at the time of transmission and reception to and from an external device (for example, communication device 2) via a transmission line, it is possible to diagnose a failure sign based on the setpoint data for transmission waveform adjustment under different conditions. As a result, the communication device itself can perform self-diagnosis, and the accuracy of failure sign diagnosis is improved. In the present embodiment, it is possible to ascertain whether or not the communication device (for example, the communication device 1) to be diagnosed is in the failure sign state.

As described above, because communication devices (components) having a failure sign can be specified, for example, only components requiring replacement can be replaced or undergo maintenance, and as a result, component costs and maintenance man-hours can be reduced.

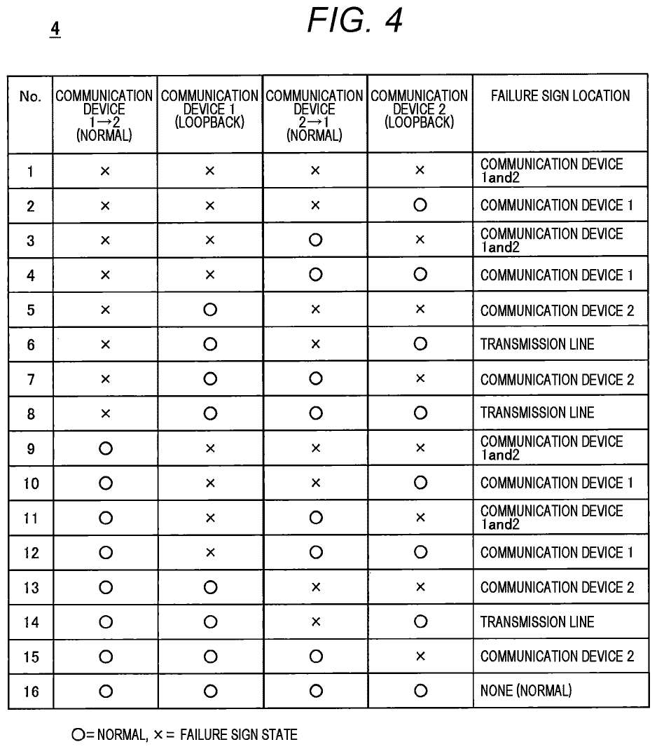

Next, grouping of the failure sign diagnosis results of two communication devices according to the present embodiment will be described with reference to FIG. 4.

FIG. 4 is a diagram illustrating a table in which failure sign diagnosis results in the two communication devices 1 and 2 are grouped. The example of FIG. 4 is an example of a case where a failure sign location is specified using the failure sign diagnosis results of the communication device 1 alone and the communication device 2 alone. In grouping table 3 illustrated in FIG. 3, an item “communication device 2 (loopback)” is added to grouping table 4 illustrated in FIG. 4. That is, grouping table 4 includes the following items: “No.” , “communication device 1→2 (normal)”, “communication device 1 (loopback)”, “communication device 2→1 (normal)”, “communication device 2 (loopback)”, and “failure sign location”.

In the present embodiment, it is assumed that a failure sign of the internal circuits of the communication device 1 and the communication device 2 can be detected by failure sign diagnosis at the time of loopback. From the grouping table 4 illustrated in FIG. 4, it can be seen that, by adding the diagnosis at the time of loopback to the diagnosis at the time of normal transmission and reception, one or a plurality of failure sign locations can be specified from among the communication device 1, the communication device 2, and the transmission line 10.

For example, the failure sign diagnosis result for “No. 3” in Table 3 illustrated in FIG. 3 corresponds to the failure sign diagnosis results in “No. 5” and “No. 6” in Table 4 of FIG. 4. In “No. 5” of Table 4, in a case where the “communication device 1→2 (normal)” is in the failure sign state, the “communication device 1 (loopback)” is normal, the “communication device 2→1 (normal)” is in the failure sign state, and the “communication device 2 (loopback)” is in the failure sign state, the communication device 2 can be specified as the failure sign location. Similarly, in “No. 6” in Table 4, in a case where the “communication device 1→2 (normal)” is in the failure sign state, the “communication device 1 (loopback)” is normal, the “communication device 2→1 (normal)” is in the failure sign state, and the “communication device 2 (loopback)” is normal, the transmission line 10 can be specified as the failure sign location.

The failure sign diagnosis result in “No. 4” in Table 3 illustrated in FIG. 3 corresponds to the failure sign diagnosis results in “No. 7” and “No. 8” in Table 4 of FIG. 4. In “No. 7” in Table 4, in a case where the “communication device 1→2 (normal)” is in the failure sign state, the “communication device 1 (loopback)” is normal, the “communication device 2→1 (normal)” is normal, and the “communication device 2 (loopback)” is in the failure sign state, the communication device 2 can be specified as the failure sign location. Similarly, in “No. 8” in Table 4, in a case where the “communication device 1→2 (normal)” is in the failure sign state, the “communication device 1 (loopback)” is normal, the “communication device 2→1 (normal)” is normal, and the “communication device 2 (loopback)” is normal, the transmission line 10 can be specified as the failure sign location.

For example, the failure sign diagnosis result in “No. 7” in Table 3 illustrated in FIG. 3 corresponds to the failure sign diagnosis results in “No. 13” and “No. 14” in Table 4 of FIG. 4. In “No. 13” in Table 4, in a case where the “communication device 1→2 (normal)” is normal, the “communication device 1 (loopback)” is normal, the “communication device 2→1 (normal)” is in the failure sign state, and the “communication device 2 (loopback)” is in the failure sign state, the communication device 2 can be specified as the failure sign location. Similarly, in “No. 14” in Table 4, in a case where the “communication device 1→2 (normal)” is normal, the “communication device 1 (loopback)” is normal, the “communication device 2→1 (normal)” is in the failure sign state, and the “communication device 2 (loopback)” is normal, the transmission line 10 can be specified as the failure sign location.

Note that, as illustrated in FIG. 4, even in a case where “communication device 2 (loopback)” is diagnosed in addition to “communication device 1→2 (normal)”, “communication device 1 (loopback)”, and “communication device 2→1 (normal)”, the diagnosis of the communication state, that is, the diagnosis of a failure sign may be performed in light of “communication device 1 (loopback)” and “communication device 2 (loopback)” for the reason illustrated in FIG. 3.

As described above, the communication system according to the present embodiment is a communication system including the first communication device (for example, the communication device 1) and the second communication device (for example, the communication device 2) that transmit data signals. The first communication device and the second communication device each include transmission circuits (the transmission processing circuit 101 to the transmission output circuit 103, and the transmission processing circuit 201 to the transmission output circuit 203) that transmit data signals, reception circuits (the reception input circuit 104 to the reception processing circuit 107, and the reception input circuit 204 to the reception processing circuit 207) ) t that receive the data signals, and setpoint data variation diagnosis units (setpoint data variation diagnosis units 109 and 209).

The setpoint data variation diagnosis unit is configured to use first setpoint data for adjusting a transmission waveform when a data signal is transmitted and received between the first communication device and the second communication device via a transmission line (communication device 1→2 (normal), communication device 2→1 (normal) ), second setpoint data for adjusting a transmission waveform when looped back between a transmission circuit and a reception circuit in the first communication device (communication device 1 (loopback) ), and third setpoint data for adjusting a transmission waveform when looped back between a transmission circuit and a reception circuit in the second communication device (communication device 2 (loopback) ), and based on a prescribed determination condition, determine a variation of the first setpoint data when the data signal is transmitted and received between the first communication device and the second communication device via the transmission line, a variation in the second setpoint data when looped back between the transmission circuit and the reception circuit in the first communication device, and a variation in the third setpoint data when looped back between the transmission circuit and the reception circuit in the second communication device, and, based on the determination result, diagnose a failure sign of the first communication device, the second communication device, and the transmission line, and specify the location having the failure sign.

With the communication system (including, for example, communication devices 1 and 2) according to the present embodiment described above, it is possible to specify in which communication device or transmission line the failure sign location is by performing the failure sign diagnosis by adding the diagnosis at the time of loopback in each communication device to the diagnosis at the time of transmission and reception between the two communication devices (for example, the communication devices 1 and 2) via the transmission line.

As described above, because communication devices (components) having a failure sign can be specified, for example, only components requiring replacement can be replaced or undergo maintenance, and as a result, component costs and maintenance man-hours can be reduced.

### Modification (1) of First Embodiment

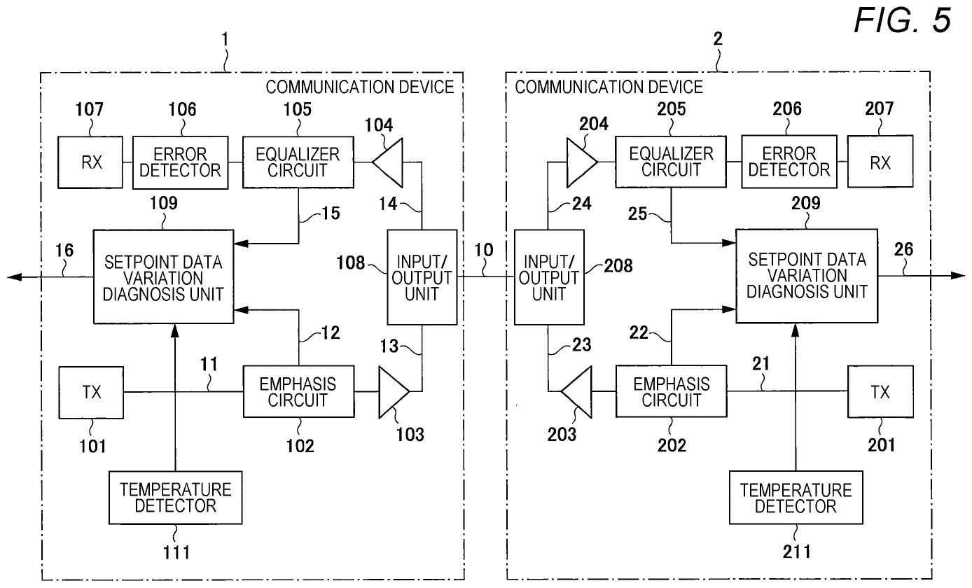

Next, a Modification (1) of the communication device according to the present embodiment will be described with reference to FIG. 5.

FIG. 5 is a block diagram illustrating an internal configuration example in a case where a temperature detector (temperature detection circuit) is provided in the communication device according to the present embodiment. This example illustrates a case where the impact of the temperature of the communication device is considered in the failure sign diagnosis.

The communication device 1 and the communication device 2 illustrated in FIG. 1 each include a temperature detector 111 and a temperature detector 211 that detect temperatures in the communication devices. The setpoint data variation diagnosis units 109 and 209 change the determination threshold values for the failure sign diagnosis according to the temperatures in the communication devices 1 and 2 detected by the temperature detectors 111 and 211. As a result, it is possible to prevent an erroneous determination as a failure sign state when the setpoint data for adjusting the transmission waveform of a data signal changes due to the impact of the temperature. As a method for changing the threshold values according to temperature, for example, a method for measuring the temperature dependency of the setpoint data at the time of a product shipment inspection and storing threshold value information corresponding to the temperature in the communication device may be considered.

### Modification (2) of First Embodiment

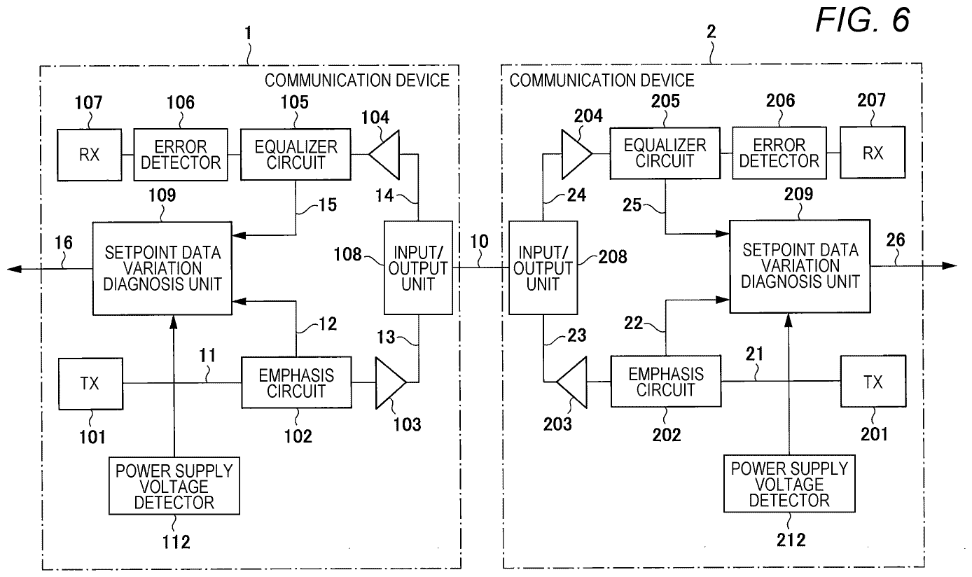

Next, a Modification (2) of the communication device according to the present embodiment will be described with reference to FIG. 6.

FIG. 6 is a block diagram illustrating an internal configuration example in a case where a power supply voltage detector (power supply voltage detection circuit) is provided in the communication device according to the present embodiment. This example illustrates a case where the impact of the power supply voltage of the communication device is considered in the failure sign diagnosis.

A power supply voltage detector 112 and a power supply voltage detector 212 are provided inside each of the communication device 1 and the communication device 2 illustrated in FIG. 1. The setpoint data variation diagnosis units 109 and 209 change the determination threshold values for the failure sign diagnosis according to the power supply voltages supplied to the communication devices 1 and 2 as detected by the power supply voltage detectors 112 and 212. As result, it is possible to prevent an erroneous determination as a failure sign state when the setpoint data for adjusting the transmission waveform of a data signal changes due to the impact of the power supply voltage. As a method for changing the threshold values according to the power supply voltage, for example, a method for measuring the power supply voltage dependency of the setpoint data at the time of product shipment inspection and storing threshold value information corresponding to the power supply voltage may be considered.

### Communication System Including Host Device

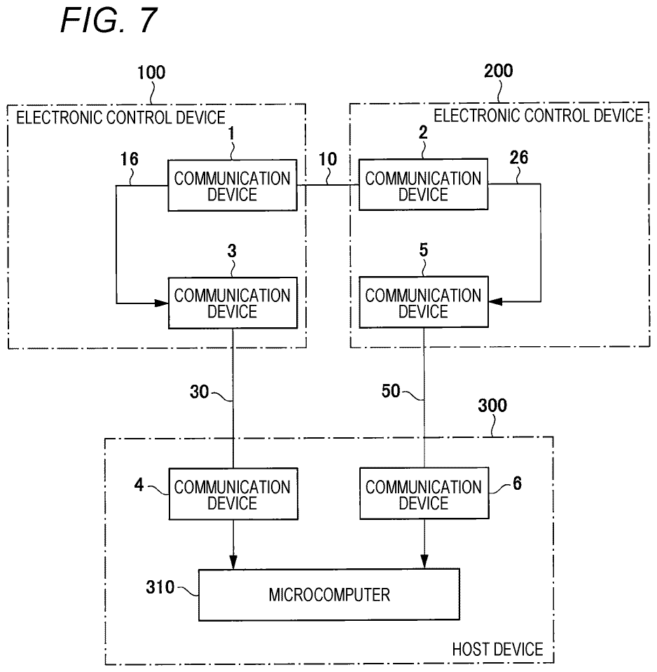

Next, a configuration, in a communication system according to the present embodiment, in which information on a failure sign diagnosis result is aggregated in a host device and a failure sign location is specified by the host device will be described with reference to FIG. 7.

FIG. 7 is a diagram illustrating an example of a configuration, in a communication system, in which information on a failure sign diagnosis result is aggregated in a host device and a failure sign location is specified by the host device. FIG. 7 illustrates a configuration example in a case where information on the failure sign diagnosis results by the setpoint data variation diagnosis units 109 and 209 of the communication device 1 and the communication device 2 is aggregated in the host device 300 and the host device 300 specifies the communication device having the failure sign location and the transmission line.

In this example, an electronic control device 100 that includes the communication device 1 further includes a communication device 3, and an electronic control device 200 that includes the communication device 2 further includes a communication device 5. In the electronic control device 100, the communication device 1 and the communication device 3 are connected via the signal line 16. Similarly, in the electronic control device 200, the communication device 2 and the communication device 5 are connected via a signal line 26. The communication device 3 may have the same configuration as the communication device 1 or may have a configuration without the setpoint data variation diagnosis unit 109 of the communication device 1. Similarly, the communication device 5 may have the same configuration as the communication device 2, or may have a configuration without the setpoint data variation diagnosis unit 209 of the communication device 2.

The host device 300 includes a communication device 4, a communication device 6, and a microcomputer 310 that specifies a failure sign location on the basis of a failure sign diagnosis result. The communication device 3 of the electronic control device 100 and the communication device 4 of the host device 300 are connected by a transmission line 30. In addition, the communication device 5 of the electronic control device 200 and the communication device 6 of the host device 300 are connected by a transmission line 50. The communication device 4 may have the same configuration as the communication device 1 or may have a configuration without the setpoint data variation diagnosis unit 109 of the communication device 1. Similarly, the communication device 6 may have the same configuration as the communication device 2, or may have a configuration without the setpoint data variation diagnosis unit 209 of the communication device 2.

The failure sign diagnosis result of the communication device 1 is transmitted from the signal line 16 to the microcomputer 310 via the communication device 3, the transmission line 30, and the communication device 4. That is, the failure sign diagnosis result of the communication device 1 is transmitted from the setpoint data variation diagnosis unit 109 to the transmission processing circuit 101 of the communication device 3 via the signal line 16. In normal data communication, the failure sign diagnosis result is transmitted from the input/output unit 108 of the communication device 3 to the input/output unit 108 of the communication device 4 via the transmission line 30. Further, the failure sign diagnosis result is transmitted from the reception processing circuit 107 of the communication device 4 to the microcomputer 310.

Similarly, the failure sign diagnosis results of the communication device 2 are transmitted from the signal line 26 to the microcomputer 310 via the communication device 5, the transmission line 50, and the communication device 6. Because a specific communication path through which the failure sign diagnosis results of the communication device 2 are transmitted from the signal line 26 to the microcomputer 310 via the communication device 5, the transmission line 50, and the communication device 6 is similar to the communication path of the failure sign diagnosis results of the communication device 1 described above, a detailed description thereof will be omitted.

The microcomputer 310 Specifies the failure sign location of the communication device 1, the communication device 2, and the transmission line 10 on the basis of the failure sign diagnosis results of the communication device 1 and the failure sign diagnosis results of the communication device 2.

Instead of the failure sign diagnosis results, the setpoint data for transmission waveform adjustment of the emphasis circuit 102 and the equalizer circuit 105 of the communication device 1 and the setpoint data for transmission waveform adjustment of the emphasis circuit 202 and the equalizer circuit 205 of the communication device 2 may be transmitted to the host device 300. The microcomputer 310 of the host device 300 is also capable of aggregating the setpoint data of each circuit transmitted by the communication device 1 and the setpoint data of each circuit transmitted by the communication device 2 to perform the failure sign diagnosis and the specification of the failure sign location.

For example, a case where a plurality of communication devices 1 to 6 are mounted in a vehicle will be considered. When there are an electronic control unit (ECU) which includes the communication device 1 and the communication device 3 and an ECU which includes the communication device 2 and the communication device 5, the host device 300 corresponds to an integrated ECU that integrally controls these ECUs.

As described above, the communication system according to the present embodiment is a communication system including the first communication device (for example, the communication device 1), the second communication device (for example, the communication device 2) , and the information processing device (the host device 300) that transmit data signals.

The first communication device and the second communication device each include transmission circuits (the transmission processing circuit 101 to the transmission output circuit 103, and the transmission processing circuit 201 to the transmission output circuit 203) that transmit data signals, reception circuits (the reception input circuit 104 to the reception processing circuit 107, and the reception input circuit 204 to the reception processing circuit 207) that receive the data signals, and setpoint data variation diagnosis units (setpoint data variation diagnosis units 109 and 209).

The setpoint data variation diagnosis unit is configured to use first setpoint data for adjusting a transmission waveform when a data signal is transmitted and received between the first communication device and the second communication device via a transmission line (communication device 1→2 (normal), communication device 2→1 (normal) ), second setpoint data for adjusting a transmission waveform when looped back between a transmission circuit and a reception circuit in the first communication device (communication device 1 (loopback) ), and third setpoint data for adjusting a transmission waveform when looped back between a transmission circuit and a reception circuit in the second communication device (communication device 2 (loopback) ), and based on a prescribed determination condition, determine a variation of the first setpoint data when the data signal is transmitted and received between the first communication device and the second communication device via the transmission line, a variation in the second setpoint data when looped back between the transmission circuit and the reception circuit in the first communication device, and a variation in the third setpoint data when looped back between the transmission circuit and the reception circuit in the second communication device, and, based on the determination result, diagnose a failure sign of the first communication device, the second communication device, and the transmission line, and specify the location having the failure sign.

The information processing device is configured to acquire the failure sign diagnosis results of the setpoint data variation diagnosis units from the first communication device and the second communication device, and specify locations having a failure sign.

With the communication system (including, for example, the communication devices 1 and 2 and the host device 300) according to the present embodiment described above, failure sign diagnosis results by a plurality of communication devices are aggregated into an external information processing device, and the information processing device is capable of specifying a failure sign location. Therefore, a failure sign location can be specified by the information processing device which has a higher data processing performance than the communication devices.

### Second Embodiment

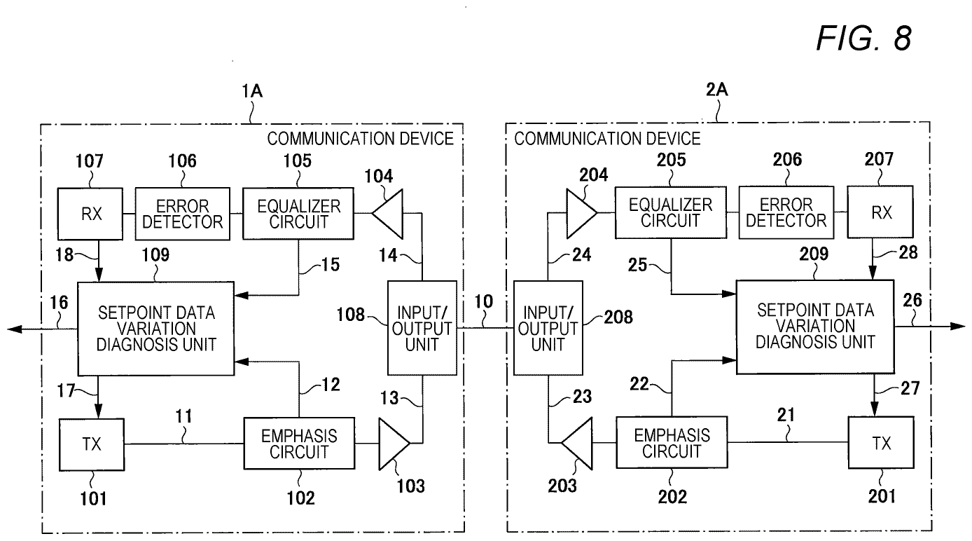

This second embodiment is an example in which a communication device specifies a failure sign location without using the host device, in the communication system (see FIG. 7) according to the first embodiment. The second embodiment will be described with reference to FIG. 8.

FIG. 8 is a diagram illustrating an example of a configuration, in a communication system according to the present embodiment, in which a failure sign location is specified by a communication device without using a host device. In the present embodiment, a signal line 17 connecting the transmission processing circuit 101 and the setpoint data variation diagnosis unit 109 and a signal line 18 connecting the reception processing circuit 107 and the setpoint data variation diagnosis unit 109 are added to the above-described communication device 1 (see FIG. 1). Similarly, a signal line 27 connecting the transmission processing circuit 201 and the setpoint data variation diagnosis unit 209 and a signal line 28 connecting the reception processing circuit 207 and the setpoint data variation diagnosis unit 209 are added to the communication device 2. The communication device 1A and the communication device 2A are described in the present embodiment in order to distinguish same from the communication device 1 and the communication device 2 described above.

The communication device 1A sends the failure sign diagnosis results of the setpoint data variation diagnosis unit 109 to the transmission processing circuit 101 via the signal line 17, and transmits the results to the communication device 2A by means of normal data communication. The failure sign diagnosis results of the communication device 1A that have arrived at the communication device 2A are transmitted from the reception processing circuit 207 to the setpoint data variation diagnosis unit 209 via the signal line 28. Because the setpoint data variation diagnosis unit 209 aggregates the failure sign diagnosis results of the communication device 1A and the communication device 2A, it is possible to specify failure sign locations of the communication device 1A, the communication device 2A, and the transmission line 10.

Conversely, the communication device 2A sends the failure sign diagnosis results of the setpoint data variation diagnosis unit 209 to the transmission processing circuit 201 via the signal line 27, and transmits the result to the communication device 1A by means of normal data communication. The failure sign diagnosis results of the communication device 2A that have arrived at the communication device 1A are transmitted from the reception processing circuit 107 to the setpoint data variation diagnosis unit 109 via the signal line 18. Because the setpoint data variation diagnosis unit 109 aggregates the failure sign diagnosis results of the communication device 1A and the communication device 2A, it is possible to specify failure sign locations of the communication device 1A, the communication device 2A, and the transmission line 10. The result of specifying a failure sign location in the communication device 1A is outputted to a device outside the communication device 1A via the signal line 16. Similarly, the result of specifying the failure sign location in the communication device 2A is outputted to a device outside the communication device 2A via the signal line 26.

### Third Embodiment

This third embodiment is an example in which a determination threshold value used in the failure sign diagnosis of the communication device is changed according to an instruction from an external device.

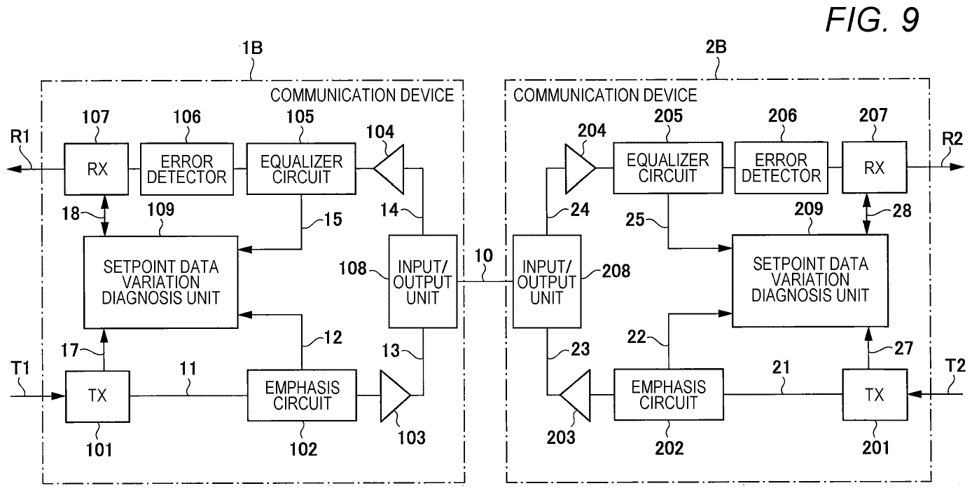

FIG. 9 is a diagram illustrating an example of a configuration, in a communication system according to the present embodiment, in which a determination threshold value used in failure sign diagnosis of a communication device is changed according to an instruction from an external device.

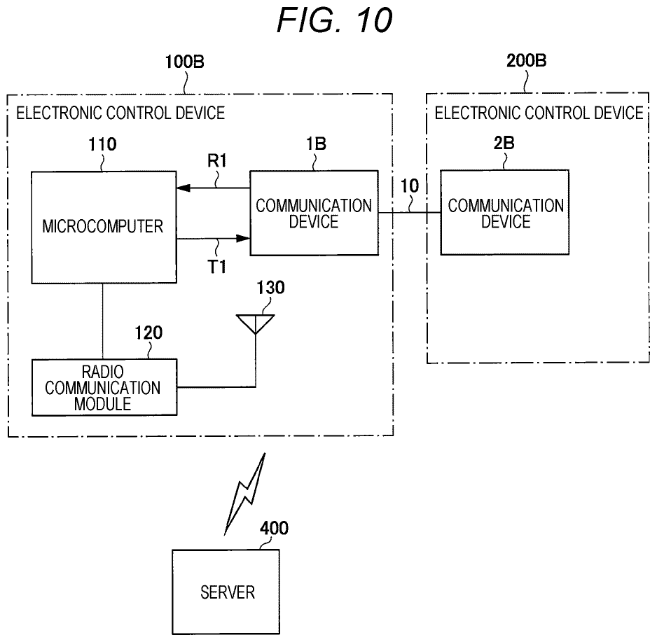

FIG. 10 is a diagram illustrating an example of a configuration, in a communication system according to the present embodiment, in which an instruction from an external device is transmitted and received between two communication devices by means of radio communication.

As illustrated in FIG. 9, the communication device 1B according to the present embodiment includes, in the above-described communication device 1A (see FIG. 8), a signal line T1 that connects the transmission processing circuit 101 and an external device, and a signal line R1 that connects the reception processing circuit 107 and the external device. Similarly, the communication device 2B includes, in the above-described communication device 2A, a signal line T2 that connects the transmission processing circuit 201 and an external device and a signal line R2 that connects the reception processing circuit 207 and the external device.

In addition, in the communication device 1B, the signal line 16 that is present in the communication device 1A and that outputs the failure sign diagnosis result from the Setpoint data variation diagnosis unit 109 is deleted, and the failure sign diagnosis result is outputted from the signal line R1 via the signal line 18 and the reception processing circuit 107. Similarly, in the communication device 2B, the signal line 26 that exists in the communication device 2A and that outputs the failure sign diagnosis result from the setpoint data variation diagnosis unit 209 is deleted, and the failure sign diagnosis result is outputted from the signal line R2 via the signal line 28 and the reception processing circuit 207.

An example of a method for changing the determination threshold value for the failure sign diagnosis of the communication device 1B and the communication device 2B according to an instruction from the external device will be described with reference to FIG. 10. In FIG. 10, an electronic control device 100B is capable of transmitting and receiving data signals to and from an electronic control device 200B via the transmission line 10. Furthermore, the electronic control device 100B is capable of using radio communication to transmit and receive data signals to and from a server 400 (an example of an external device). The electronic control device 200B has a wired communication function, but may have a configuration similar to that of the electronic control device 100B having a radio communication function.

For example, in a case where radio communication is used, instruction data from an external device (for example, the server 400) received by an antenna 130 installed in the electronic control device 100B is sent to the microcomputer 110 responsible for controlling the electronic control device 100B via the radio communication module 120. The instruction data from the external device includes information for changing the determination threshold value for the failure sign diagnosis. Further, instruction data from the external device is transmitted from the microcomputer 110 to the transmission processing circuit 101 of the communication device 1B via the signal line T1. In the communication device 1B, the instruction data is delivered from the transmission processing circuit 101 to the setpoint data variation diagnosis unit 109 via the signal line 17. Therefore, the setpoint data variation diagnosis unit 109 is capable of changing the determination threshold value for the failure sign diagnosis according to an instruction from an external device.

Meanwhile, in the communication device 2B installed in the electronic control device 200B, the instruction data from the external device is delivered to the setpoint data variation diagnosis unit 209 via the communication device 1B, the transmission line 10, the reception circuit from the input/output unit 208 to the reception processing circuit 207, and the signal line 28. Therefore, the setpoint data variation diagnosis unit 209 is capable of changing the determination threshold value for the failure sign diagnosis according to an instruction from an external device.

In this manner, the setpoint data variation diagnosis units 109 and 209 is capable of acquiring an instruction from the external device via the communication network using radio communication and of changing the threshold value of the failure sign diagnosis on the basis of the instruction from the external device. For example, in the case of an in-vehicle communication device, the setpoint data variation diagnosis units 109 and 209 in the communication devices are capable of acquiring information on a failure occurrence situation in the same vehicle type as an instruction from the external device, and of changing the determination condition from the information on the failure occurrence situation to improve the accuracy of the failure sign diagnosis. For example, changing the determination condition means changing the threshold value as illustrated in FIG. 2. As an example, in a case where it is desired to find a failure sign of a certain component at an early stage on the basis of a failure occurrence situation in the same vehicle type, it is conceivable to take a measure to reduce the value of the threshold value TH-U3 to approach the threshold value TH-U2.

In the example of FIG. 10, conversely, it is also possible to transmit the failure sign diagnosis results of the communication device 1B and the communication device 2B and the setpoint data for transmission waveform adjustment to a device outside the communication device 1 and the communication device 2, for example, the server 400 or the like, by using radio communication. The server 400 is capable of performing the failure sign diagnosis by using the transmitted failure sign diagnosis results and the transmission waveform adjustment setpoint data. In addition, the server 400 is also capable of returning the obtained failure sign diagnosis results to the electronic control devices 100B and 200B (the communication devices 1B and 2B) or the like by using radio communication. For example, in the case of in-vehicle communication, radio communication configured from the radio communication module 120 and the antenna 130 corresponds to Over-The-Air (OTA).

Note that the external device may be a maintenance terminal used by a maintenance worker for maintenance. The maintenance terminal and the electronic control devices 100B and 200B are communicably connected by connecting the maintenance terminal to a connector which is connected to the in-vehicle Ethernet. The maintenance worker operates the maintenance terminal to transmit an instruction to change the threshold value for the failure sign diagnosis to the communication devices 1B and 2B of the electronic control devices 100B and 200B.

### Hardware Configuration of Computer

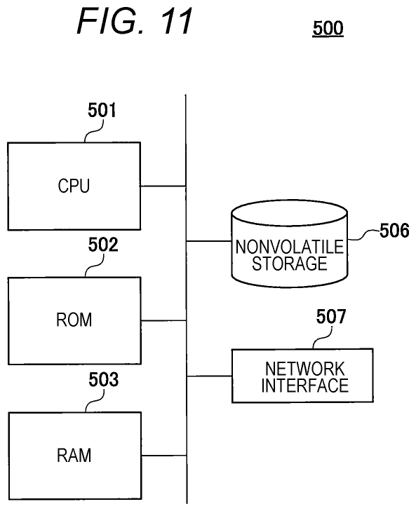

Next, a hardware configuration of a computer included in the communication device, the microcomputer, and the server in each of the above-described embodiments will be described with reference to FIG. 11.

FIG. 11 is a block diagram illustrating a hardware configuration example of a computer included in communication device, a microcomputer, and a server according to the embodiments of the present invention. A computer 500 illustrated in FIG. 11 is hardware used as a so-called computer.

The computer 500 includes a central processing unit (CPU) 501, a read-only memory (ROM) 502, and a random-access memory (RAM) 503, a nonvolatile storage 506, and a network interface 507, which are each connected to a bus.

The CPU 501 is an example of a processor which serves as a computation device. The ROM 502 and the RAM 503 are examples of memory.

The nonvolatile storage 506 is a nonvolatile storage element having a larger capacity than the memory. A program for implementing the functions of the communication device according to each embodiment of the present invention is stored in the nonvolatile storage 506. The nonvolatile storage 506 is an example of a computer-readable non-transitory recording medium. Note that the program may be stored in the ROM 502. At least in a case where the functions of the setpoint data variation diagnosis units 109 and 209 are implemented by software, the functions of the setpoint data variation diagnosis units are implemented by the CPU 501 executing the program stored in the ROM 502 or the nonvolatile storage 506.

In addition, the nonvolatile storage 506 may store determination threshold values for the failure sign diagnosis used by the setpoint data variation diagnosis units 109 and 209 in the communication device (FIG. 2), the grouping of the failure sign diagnosis results (FIGS. 3 and 4), and data which is obtained by chronologically acquiring the setpoint data for the transmission waveform adjustment (FIG. 2), and the like.

In addition, in a case where the microcomputer 310 of the host device 300 in FIG. 7 or the server 400 of FIG. 10 is provided with a function for diagnosing a failure sign or a function for specifying a failure sign location, a program that implements the same functions as the setpoint data variation diagnosis units 109 and 209 is recorded in the ROM 502 or the nonvolatile storage 506 included in the microcomputer 310 and the server 400.

The network interface 507 includes i a communication device or the like that controls communication performed with another device (for example, an ECU) via a communication line or a network such as an in-vehicle Ethernet. For example, the input/output units 108 and 208 of the communication device are implemented by means of the network interface 507. In addition, the radio communication module 120 in the electronic control device 100B of FIG. 10 is an example of the network interface 507.

Note that the present invention is not limited to or by the above-described embodiments, and it is obvious that various other application examples and modifications can be employed without departing from the gist of the present invention described in the claims. For example, the above-described embodiments describe configurations of the present invention in detail and in specific terms in order to describe the invention in an easy-to-understand manner, and are not necessarily limited to those having all the described configurations. Further, some of the configurations of one embodiment can be replaced with components of another embodiment. In addition, components of another embodiment can be added to the configuration of the one embodiment. Furthermore, it is also possible to add, delete, and replace other configurations with some of the configurations of the present embodiment.

In addition, some or all of the above-described configurations, functions, processing units, and the like may be implemented by hardware, for example, through an integrated circuit design. A processor device in a broad sense such as a field programmable gate array (FPGA) or an application specific integrated circuit (ASIC) may be used as hardware. Further, each of the above-described configurations, functions, and the like may be implemented by software as a result of a processor parsing and executing a program for implementing each function.

Moreover, in the above-described embodiments, control lines and information lines indicate what is deemed necessary for the description, and do not necessarily indicate all the control lines and the information lines on the product. In practice, almost all the configurations may be considered to be interconnected.

### REFERENCE SIGNS LIST

1 to 6 communication device
1A, 2A communication device
1B, 2B communication device
10, 30, 50 transmission line
101, 201 transmission processing circuit
102, 202 emphasis circuit
103, 203 transmission output circuit
104, 204 reception input circuit
105, 205 equalizer circuit
106, 206 error detector
107, 207 reception processing circuit
108, 208 input/output unit
109, 209 setpoint data variation adjustment unit
100, 200 electronic control device
100B, 200B electronic control device
111, 211 temperature detector
112, 212 power supply voltage detector
300 host device
110, 310 microcomputer

1. A communication device that transmits a data signal, the communication device comprising:
a transmission circuit configured to transmit the data signal;
a reception circuit configured to receive the data signal; and
a setpoint data variation diagnosis unit that,
using first setpoint data for adjusting a transmission waveform when the data signal is transmitted and received to and from an external device via a transmission line, and
second setpoint data for adjusting a transmission waveform when the data signal is looped back between the transmission circuit and the reception circuit,
is configured to determine, based on a prescribed determination condition, each of a variation in the first setpoint data when the data signal is transmitted and received to and from the external device via the transmission line and a variation in the second setpoint data when the data signal is looped back between the transmission circuit and the reception circuit, and is configured to diagnose, based on determination results, failure signs of the communication device and the transmission line.

2. The communication device according to claim 1,
wherein the first setpoint data and the second setpoint data for adjusting a transmission waveform are setpoints of tap coefficients of a transfer function of an emphasis circuit or Setpoints of tap coefficients of a transfer function of an equalizer circuit.

3. The communication device according to claim 1,
wherein the timing at which the setpoint data variation diagnosis unit diagnoses a failure sign is at the time of activation of the communication device or at the time of termination thereof.

4. The communication device according to claim 1, further comprising
a temperature detection circuit configured to detect a temperature in the communication device,
wherein the setpoint data variation diagnosis unit changes the determination condition in accordance with the temperature detected by the temperature detection circuit.

5. The communication device according to claim 1, further comprising
a power supply voltage detection circuit configured to detect a power supply voltage supplied to the communication device,
wherein the setpoint data variation diagnosis unit changes the determination condition according to the power supply voltage detected by the power supply voltage detection circuit.

6. The communication device according to claim 1,
wherein the setpoint data variation diagnosis unit changes the determination condition on the basis of an instruction from an external device of the communication device.

7. The communication device according to claim 1,
wherein the setpoint data variation diagnosis unit diagnoses the failure signs based on a plurality of threshold values or temporal variations in time-series data of the first setpoint data and the second setpoint data.

8. A communication system that includes a first communication device and a second communication device that transmit a data signal,
each of the first communication device and the second communication device comprising:
a transmission circuit configured to transmit the data signal;
a reception circuit configured to receive the data signal; and
a setpoint data variation diagnosis unit that,
using first setpoint data for adjusting a transmission waveform when the data signal is transmitted and received to and from the first communication device and the second communication device via a transmission line,
second setpoint data for adjusting a transmission waveform when the data signal is looped back between the transmission circuit and the reception circuit in the first communication device, and
third setpoint data for adjusting a transmission waveform when the data signal is looped back between the transmission circuit and the reception circuit in the second communication device,
is configured to determine, based on a prescribed determination condition, each of a variation in the first setpoint data when the data signal is transmitted and received between the first communication device and the second communication device via the transmission line, a variation in the second setpoint data when the data signal is looped back between the transmission circuit and the reception circuit in the first communication device, and a variation in the third setpoint data when the data signal is looped back between the transmission circuit and the reception circuit in the second communication device and is configured to diagnose, based on determination results, failure signs of the first communication device, the second communication device, and the transmission line, and specify locations having the failure signs.

9. A communication system that includes a first communication device, a second communication device, and an information processing device that transmit a data signal,
each of the first communication device and the second communication device comprising:
a transmission circuit configured to transmit the data signal;
a reception circuit configured to receive the data signal;
a setpoint data variation diagnosis unit that,
using first setpoint data for adjusting a transmission waveform when the data signal is transmitted and received to and from the first communication device and the second communication device via a transmission line,
second setpoint data for adjusting a transmission waveform when the data signal is looped back between the transmission circuit and the reception circuit in the first communication device, and
third setpoint data for adjusting a transmission waveform when the data signal is looped back between the transmission circuit and the reception circuit in the second communication device,
is configured to determine, based on a prescribed determination condition, each of a variation in the first setpoint data when the data signal is transmitted and received between the first communication device and the second communication device via the transmission line, a variation in the second setpoint data when the data signal is looped back between the transmission circuit and the reception circuit in the first communication device, and a variation in the third setpoint data when the data signal is looped back between the transmission circuit and the reception circuit in the second communication device, and is configured to diagnose, based on determination results, failure signs of the first communication device, the second communication device, and the transmission line,
wherein the information processing device acquires the failure sign diagnosis results by the setpoint data variation diagnosis unit from the first communication device and the second communication device, and specifies locations having the failure signs.

10. A failure sign diagnosis method executed by a communication device that transmits and receives a data signal by means of a transmission circuit and a reception circuit, the method including:
processing that uses first setpoint data for adjusting a transmission waveform when the data signal is transmitted and received to and from an external device via a transmission line and second setpoint data for adjusting a transmission waveform when the data signal is looped back between the transmission circuit and the reception circuit to determine, based on a prescribed determination condition, each of a variation in the first setpoint data when the data signal is transmitted and received to and from the external device via the transmission line and a variation in the second setpoint data when the data signal is looped back between the transmission circuit and the reception circuit; and
processing to diagnose, based on determination results, failure signs of the communication device and the transmission line.
